(19) United States
(12) Patent Application Publication
(10) Pub. No.: US 2024/0416245 A1
(43) Pub. Date: Dec. 19, 2024

(54) STORAGE MEDIUM, INFORMATION PROCESSING SYSTEM, INFORMATION PROCESSING APPARATUS AND INFORMATION PROCESSING METHOD

(71) Applicant: NINTENDO CO., LTD., Kyoto (JP)

(72) Inventor: Ayako MORIWAKI, Kyoto (JP)

(21) Appl. No.: 18/616,769

(22) Filed: Mar. 26, 2024

(30) Foreign Application Priority Data
Jun. 14, 2023 (JP) 2023-097549

(51) Int. Cl. A63F 13/69; A63F 13/44; A63F 13/52; A63F 13/5375

(52) U.S. Cl. CPC A63F 13/69; A63F 13/44; A63F 13/52; A63F 13/5375

(57) ABSTRACT

A game apparatus that is a non-limiting example information processing apparatus includes a processor, and the processor makes a player object perform a predetermined action based on an operation input by a player. During a time period that the predetermined action is performed, it is judged whether a predetermined operation input by the player is performed on a timing associated in advance with this predetermined action. A game situation of a virtual game is updated in different manners according to judgment results. The above-described timing is presented to the payer by displaying a guide image, and when the number of times that the predetermined operation input by the player is performed on the above-described timing satisfies a change condition, a state is changed to a state that the guide image is not to be displayed. Moreover, when the number of times that the predetermined operation input by a player is not performed on the above-described timing satisfies a change condition, the state is changed to a state that the guide image is to be displayed.

### CROSS REFERENCE OF RELATED APPLICATION

This application claims a priority to Japanese Patent Application No. 2023-97549 filed on Jun. 14, 2023, and the entire contents of which are incorporated herein by reference.

### FIELD

This application describes a storage medium, an information processing system, an information processing apparatus and an information processing method, which causing a character object to execute a predetermined action in a virtual space.

### BACKGROUND AND SUMMARY

In the conventional game apparatus, a CPU acquires data corresponding to a type of an enemy object, and performs operation processing. When it is a chance timing period that a count value is equal to or more than a chance timing starting count value and less than a chance timing ending count value that are set in a correspondence motion table, the CPU performs action icon display processing, and determine whether the A button is turned on. The CPU performs special attack processing based on the correspondence motion table when the A button is turned on. With such a conventional game apparatus, during the chance timing period that a special attack is available, action display processing is performed, so that an icon object indicating a change timing state is represented on a CRT. This icon object indicating the chance timing state is represented as an icon so that a player can easily see the same input portion as an icon object in a normal mode, but instructions given to the game apparatus differ. Therefore, the player can know that it is the chance timing period that a special attack is available based on the representation of the icon object.

However, since the representation of the icon object is changed for each time in the chance timing period in the above-described game apparatus, the player determines a timing of an operation input by looking only at the representation of the icon object while not looking at an action of the enemy object, and therefore, there is a possibility that it may be perceived as a work-like task by the player. On the other hand, when the representation of the icon object is not performed, the chance timing period is difficult to be understood, and could be an unreasonable specification for the player.

This application discloses a novel storage medium, information processing system, information processing apparatus and information processing method.

Moreover, this application discloses a storage medium, information processing system, information processing apparatus and information processing method, capable of presenting, without spoiling interest of a game, a timing that an operation input by a player is to be performed.

A first embodiment is a non-transitory computer-readable storage medium having stored with an information processing program executable by a computer of an information processing apparatus that is capable of executing a game and comprises one or more processors, wherein the information processing program causes the one or more processors of the computer to execute: making a character object utilized in the game perform a predetermined action; acquiring operation input data to an operation input portion by a player; judging, during a time period that the character object executes the predetermined action, whether an operation input by the player is performed on a timing that is associated in advance with the predetermined action, based on the operation input data; updating a game situation of the game with a first manner when it is judged that the operation input by the player is not performed on the timing, and updating the game situation of the game with a second manner different from the first manner when it is judged that the operation input by the player is performed on the timing; presenting, on the timing, a guide corresponding to the timing when a guide presentation flag is turned on; storing number of success times that the operation input by the player is performed on the timing, in a storage; and turning the guide presentation flag off when the number of success times satisfies a first change condition.

According to the first embodiment, the guide is not presented on the timing associated in advance with the predetermined action by turning the guide presentation flag off in a case where the number of success times satisfies the first change condition, and therefore, it is possible to prevent as much as possible from being perceived as a work that just requires an operation input while seeing the timing. That is, it is possible to present the timing that the operation input is to be performed by the player, without spoiling interest of the game.

A second embodiment is the storage medium according to the first embodiment, wherein the information processing program causes the one or more processors to execute: storing number of failure times that the operation input by the player is not performed on the timing, in the storage; and turning the guide presentation flag on when the number of failure times that the operation input by the player is not performed on the timing satisfies a second change condition after turning the guide presentation flag off.

According to the second embodiment, the guide is presented on the timing associated in advance with the predetermined action by turning the guide presentation flag on in a case where the number of failure times satisfies the second change condition, and therefore, it is possible to present the timing as necessary. That is, it is possible to present the timing that the operation input is to be performed by the player, without spoiling interest of the game.

A third embodiment is the storage medium according to the first embodiment, wherein the information processing program causes the one or more processors to execute: updating the game situation based on one predetermined action among a plurality of predetermined actions; and storing the number of success times in the storage for each of the plurality of actions.

According to the third embodiment, it is possible to present the timing for each of a plurality of predetermined actions, or not to present.

A fourth embodiment is the storage medium according to the first embodiment, wherein the information processing program causes the one or more processors to execute: updating the game situation in favor of the player in a case where it is judged that the operation input is performed on the timing compared to a case where it is not judged that the operation input is performed on the timing.

According to the fourth embodiment, there is the enjoyment of performing an operation input on the timing associated in advance with the predetermined action in addition to simply controlling the actions of character objects.

A fifth embodiment is the storage medium according to the first embodiment, wherein the game is a game that an enemy character object and the character object engage a battle, wherein the information processing program causes the one or more processors to execute: updating the game situation by changing a life parameter associated with the enemy character object by using a first value corresponding to the predetermined action.

A sixth embodiment is the storage medium according to the fifth embodiment, wherein the information processing program causes the one or more processors to execute: updating the game situation by changing the life parameter by using a value larger than the first value in the case where it is judged that the operation input by the player is performed on the timing.

According to the sixth embodiment, in a case where the operation input by the player is performed on the timing associated in advance with the predetermined action, it is possible to reduce the life parameter of the enemy character object more than a case where the operation input by the player is not performed on the timing.

A seventh embodiment is the storage medium according to the fifth embodiment, wherein the information processing program causes the one or more processors to execute: making the enemy character object execute an enemy character action; judging, during a time period that the enemy character object executes the enemy character action, whether an operation input by the player is performed on a timing that is associated in advance with the enemy action, based on the operation input data; updating the life parameter associated with the character object by using a second value corresponding to the enemy character action in a case where it is judged that the operation input is not performed; updating the game situation by changing the life parameter associated with the character object by using a value smaller than the second value in the case where it is judged that the operation input is performed; and presenting, in a case where the guide presentation flag associated with the enemy character action is turned-on on the timing associated in advance with the enemy character action, a guide corresponding to this timing.

According to the seventh embodiment, in a case where the operation input by the player is performed on the timing associated in advance with the enemy character action, it is possible to reduce the life parameter of the character object lesser than a case where the operation input by the player is not performed on the timing.

An eighth embodiment is the storage medium according to the fifth embodiment, wherein the game is a game that a plurality of enemy character objects and the character object engage a battle, wherein the information processing program causes the one or more processors to execute: changing the life parameters associated with a first number of enemy character objects among the plurality of enemy character objects in a case where it is judged that the operation input by the player is not performed; and updating the game situation by changing the life parameters associated with a second number of enemy character objects among the plurality of enemy character objects larger than the first number of enemy character objects in a case where it is judged that the operation input by the player is performed on the timing.

According to the eighth embodiment, in a case where the operation input by the player is performed on the timing associated in advance with the predetermined action, it is possible to increase the number of enemy character objects the life parameter each of which is to be changed, instead of changing the life parameter of the enemy character object that the character object attacks.

Ninth embodiment is an information processing system capable of executing a game, wherein the information processing system causes one or more processors to execute: making a character object utilized in the game perform a predetermined action; acquiring operation input data to an operation input portion by a player; judging, during a time period that the character object executes the predetermined action, whether an operation input by the player is performed on a timing that is associated in advance with the predetermined action, based on the operation input data; updating a game situation of the game with a first manner when it is judged that the operation input by the player is not performed on the timing, and updating the game situation of the game with a second manner different from the first manner when it is judged that the operation input by the player is performed on the timing; presenting, on the timing, a guide corresponding to the timing when a guide presentation flag is turned on; storing number of success times that the operation input by the player is performed on the timing, in a storage; and turning the guide presentation flag off when the number of success times satisfies a change condition.

A tenth embodiment is an information processing apparatus that is capable of executing a game and causes one or more processors of the information processing making a character object utilized in the game perform a apparatus to execute: predetermined action; acquiring operation input data to an operation input portion by a player; judging, during a time period that the character object executes the predetermined action, whether an operation input by the player is performed on a timing that is associated in advance with the predetermined action, based on the operation input data; updating a game situation of the game with a first manner when it is judged that the operation input by the player is not performed on the timing, and updating the game situation of the game with a second manner different from the first manner when it is judged that the operation input by the player is performed on the timing; presenting, on the timing, a guide corresponding to the timing when a guide presentation flag is turned on; storing number of success times that the operation input by the player is performed on the timing, in a storage; and turning the guide presentation flag off when the number of success times satisfies a first change condition.

An eleventh embodiment is an information processing method of an inform processing apparatus capable of executing a game, wherein a computer of the information processing apparatus executes: making a character object utilized in the game perform a predetermined action; acquiring operation input data to an operation input portion by a player; judging, during a time period that the character object executes the predetermined action, whether an operation input by the player is performed on a timing that is associated in advance with the predetermined action, based on the operation input data; updating a game situation of the game with a first manner when it is judged that the operation input by the player is not performed on the timing, and updating the game situation of the game with a second manner different from the first manner when it is judged that the operation input by the player is performed on the timing; presenting, on the timing, a guide corresponding to the timing when a guide presentation flag is turned on; storing number of success times that the operation input by the player is performed on the timing, in a storage; and turning the guide presentation flag off when the number of success times satisfies a change condition.

According also to each of the ninth embodiment, the tenth embodiment and the eleventh embodiment, similar to the first embodiment, it is possible to present the timing that the operation input is to be performed by the player, without spoiling interest of the game.

The features, aspects and advantages of the embodiment(s) will become more apparent from the following detailed description when taken in conjunction with the accompanying drawings.

### BRIEF DESCRIPTION OF THE DRAWINGS

FIG. 1 is a block diagram showing non-limiting example electric structure of a game apparatus.

FIG. 2 is a view showing a non-limiting example game screen displayed on a display device of the game apparatus shown in FIG. 1.

FIG. 3 is a view showing another non-limiting example game screen displayed on the display device of the game apparatus shown in FIG. 1.

FIG. 4 is a view showing a non-limiting time variation of animation frames in a case where a player object performs an action of punching.

FIG. 5 is a view showing a further non-limiting example game screen displayed on the display device of the game apparatus shown in FIG. 1.

FIG. 6 is a view showing a non-limiting example memory map of a RAM incorporated in the game apparatus shown in FIG. 1.

FIG. 7 is a view showing non-limiting example specific contents of a data storage area of the RAM shown in FIG. 6.

FIG. 8 is a flowchart showing non-limiting example overall processing of a virtual game by a processor incorporated in the game apparatus shown in FIG. 1.

FIG. 9 is a flowchart showing a first part of non-limiting example game control processing by the processor incorporated in the game apparatus shown in FIG. 1.

FIG. 10 is a flowchart showing a second part of the non-limiting example game control processing by the processor incorporated in the game apparatus shown in FIG. 1, following FIG. 9.

FIG. 11 is a flowchart showing a third part of the non-limiting example game control processing by the processor incorporated in the game apparatus shown in FIG. 1, following FIG. 10.

FIG. 12 is a flowchart showing a fourth part of the non-limiting example game control processing by the processor incorporated in the game apparatus shown in FIG. 1, following FIG. 9.

FIG. 13 is a flowchart showing a fifth part of the non-limiting example game control processing by the processor incorporated in the game apparatus shown in FIG. 1, following FIG. 12.

### DETAILED DESCRIPTION OF NON-LIMITING EXAMPLE EMBODIMENTS

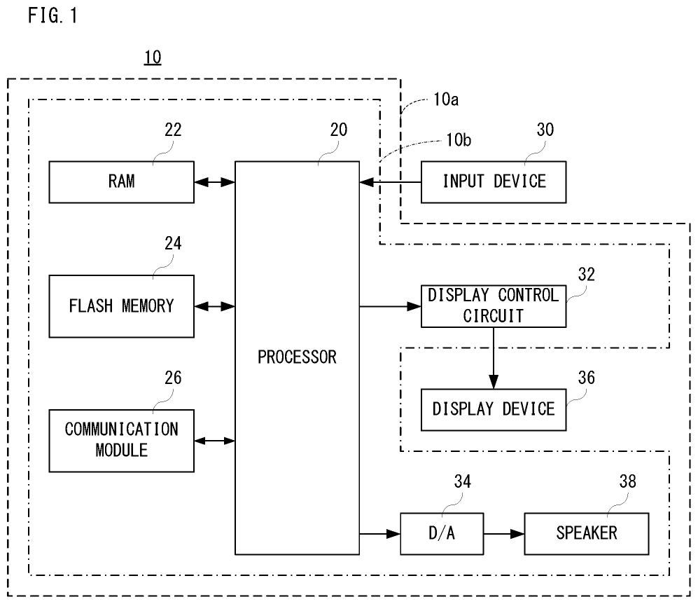

With reference to FIG. 1, a game apparatus 10 that is a non-limiting example information processing apparatus includes a processor 20, and the processor 20 is connected with a RAM 22, a flash memory 24, a communication module 26, an input device 30, a display control circuit 32 and a D/A converter 34. Moreover, the display control circuit 32 is connected with a display device 36, and the D/A converter 34 is connected with a speaker 38.

The processor 20 is in charge of overall control of the game apparatus 10. The processor 20 may be an SoC (System-on-a-chip) that incorporates therein functions of a CPU and a GPU. The RAM 22 is a volatile storage medium and is used as a working memory and a buffer memory for the processor 20. The flash memory 24 is a non-volatile storage medium, and is used in order to store a various kinds of application programs, store (save) various kinds of data. For example, the application program and required data are read from the flash memory 24 to be stored in the RAM 22.

However, the application corresponds to applications regarding various kinds of information processing, such as a game application, a document creation application, an email application, a drawing application, a character practice application, a language training application, a learning application, etc.

The communication module 26 has a function that connects to a wireless LAN according to a system conforming to a standard of IEEE 802.11.b/g, for example. Therefore, the processor 20 transmits or receives data to or from a further apparatus via an access point and a network such as Internet using the communication module 26, for example. For example, the further apparatus is a computer such as a server or other game apparatus 10. However, it is possible to directly transmit or receive data to or from such a further apparatus using the communication module 26.

However, in different from the function of connecting to a wireless LAN, the communication module 26 may have a function of performing a short-distance wireless communication. Specifically, the communication module 26 has a function that performs transmitting/receiving of an infrared ray signal with a further apparatus by a predetermined communication system (e.g., an infrared ray system), and a function that performs a wireless communication with the same kind of game apparatuses in accordance with a predetermined communication protocol (e.g., a multilink protocol). In this case, the processor 20 can directly transmit or receive data to or from other same kinds of game apparatuses using the communication module 26, for example. However, instead of the short-distance wireless communication of the infrared ray system, a short-distance wireless communication according to a further wireless communication standard, such as Bluetooth (registered trademark) may be performed.

The input device 30 is a game controller provided with various kinds of push buttons, keys or switches that are provided on the game apparatus 10, for example, and is used by a user or player (hereinafter, referred to as “player”) for various kinds of operations, such as menu selection, instructions in an application. For example, the game controller is provided with an A button, a B button, an X button, a Y button, an L button, an R button, a cross button (and/or a slide stick), etc. However, in a case of a portable game apparatus 10, in addition to the push buttons, keys or switches, a touch panel may be provided as the input device 30.

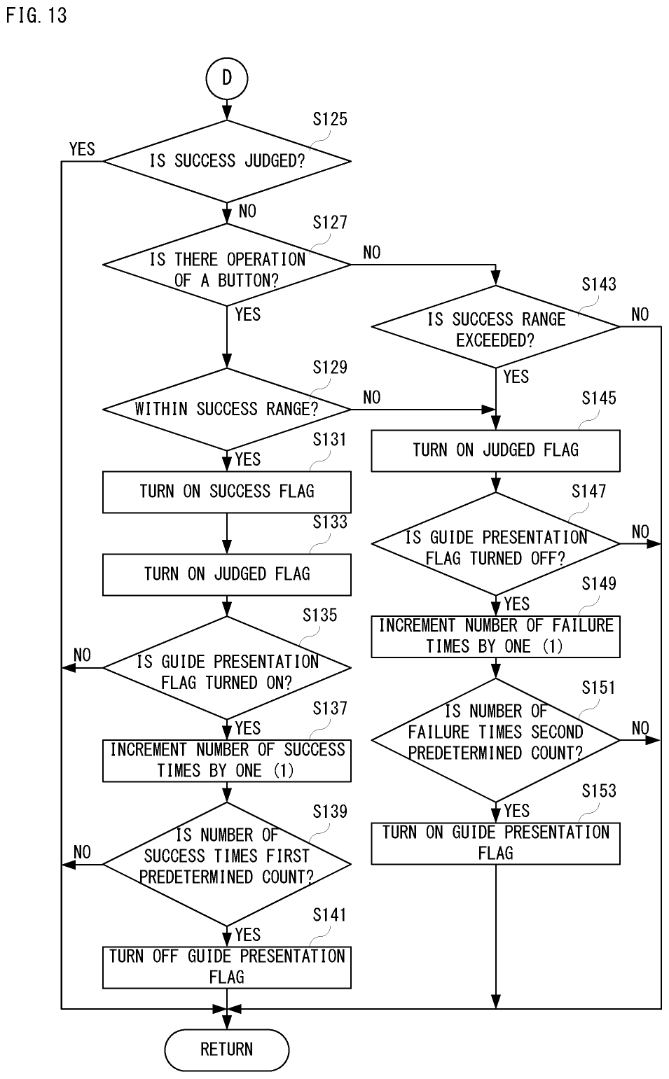

The display control circuit 32 includes a GPU, a VRAM, etc. and the GPU generates in the VRAM, under instructions by the processor 20, image data in order to display various kinds of screens on the display device 36 with using image generation data 504b (see FIG. 13), and outputs generated image data to the display device 36.

The D/A converter 34 converts sound data given from the processor 20 into an analog audio signal, and outputs the same to the speaker 38. However, the sound data may be data regarding the music, such as a sound generated by a character or object, a sound effect and a BGM.

In addition, the electric structure of the game apparatus 10 shown in FIG. 1 is a mere example, and should not need to be limited to this. For example, the communication module 26 may be omitted.

Moreover, the input device 30 may be a game controller provided separately from a main body apparatus 10a of the game apparatus 10, and connected communicably to the processor 20 with a wire or wireless. In this case, the game apparatus 10 constitutes a game system that the main body apparatus 10a and the input device 30 are communicably connected to each other.

Furthermore, in addition to the input device 30, the display device 36 may also be provided separately from a main body apparatus 10b of the game apparatus 10, and connected communicably to the processor 20 with a wire or wireless. In this case, the game apparatus 10 constitutes a game system that the main body apparatus 10b, the input device 30 and the display device 36 are communicably connected to each other. Moreover, as the display device 36, a stationary monitor such as an LCD or an organic EL can be used.

Furthermore, as the game apparatus 10, it is possible to use a game dedicated machine of a portable type or stationary type as well as other information processing apparatuses capable of functioning as a game machine, such as a personal computer, a tablet terminal, a wearable terminal, a cellular phone and a smartphone.

The game apparatus 10 functions also as an image processing apparatus, and generates and outputs (displays) image data corresponding to various kinds of screens such as a game screen. Briefly describing, the GPU incorporated in the display control circuit 32 models, under the control by the processor 20, various kinds of character objects in a three-dimensional virtual space. That is, various kinds of character objects are generated or arranged in the virtual space, whereby a certain sight or situation (scene) can be generated. An image that this scene is imaged by a virtual camera (seen from a viewpoint) is displayed on the display device 36. Describing specific image processing, at first, a certain scene is generated in the three-dimensional (or world coordinate system) virtual space, and the scene generated in the virtual space is converted into a coordinate system (i.e., camera coordinate system) that the scene is captured by the virtual camera. For example, an image that is seen from the viewpoint is projected with a perspective manner onto a virtual screen. Next, clipping and hidden-surface-removal processing are performed. Subsequently, brightness (shadow) of a surface of a character object is represented by performing shading. Furthermore, shadowing (i.e., shadow casting) is applied to represent a shadow caused by the character object. Then, texture mapping is performed. Thus, a two-dimensional image regarding a certain scene generated in the three-dimensional virtual space is generated (drawn), and two-dimensional image data corresponding to the generated two-dimensional image is output to the display device 36.

In addition, instead of performing shadowing, a shadow texture of a simple shape (e.g., circular, oval, triangular or rectangular) may be pasted, in generating the three-dimensional image.

If the player instructs execution of a game application of a virtual game according to the embodiment using the game apparatus 10, the virtual game will be started. The virtual game can be started from the beginning or from a point saved last time.

The virtual game of the embodiment is a so-called RPG, and in a virtual space, a player character object (hereinafter, referred to as “character object”) is moved according to an operation of the player, and if encountering an enemy character object (hereinafter, referred to as “enemy object”), plays against the enemy object. However, the enemy object is operated by a computer as an opponent (i.e., processor 20).

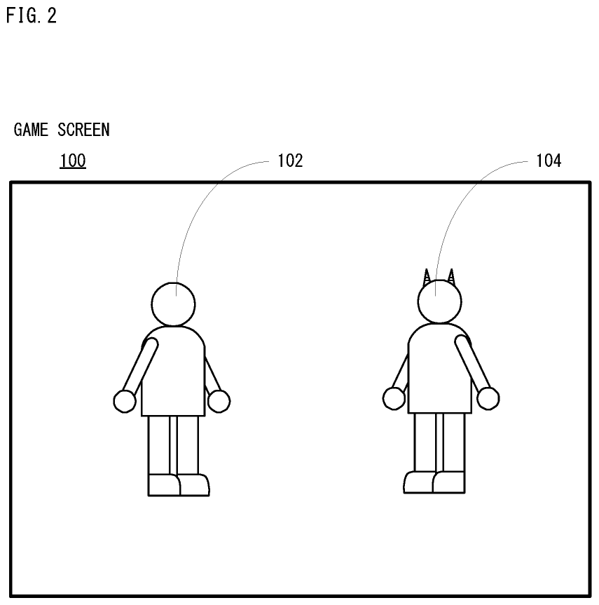

FIG. 2 is a view showing a non-limiting example game screen 100 in a battle scene. In the game screen 100, the player object 102 and the enemy object 104 are displayed in a state of confronting each other. Background objects are omitted. As an example, in the battle scene, processing of a battle between the player object 102 and the enemy object 104 is performed on a turn-based system.

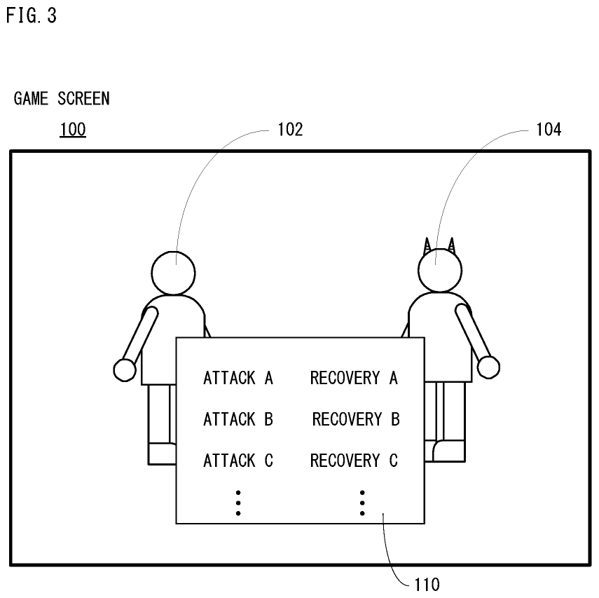

In a turn of the player, as shown in FIG. 3, a selection screen 110 for selecting and determining a command is displayed in front of the game screen 100. In the selection screen 110, items for selecting a type of attack (or type of attack technique) and a type of recovery, i.e., commands are displayed. However, the type of recovery is a type of skill that makes a life parameter (hereinafter, referred to as “HP”) of the player object 102 recover.

Attack A, attack B, attack C, and - - - are displayed in the selection screen 110. However, as for the type of attack, there may be one or two or more. The types of attack are increased as the player object 102 learns techniques, and also increased or changed depending on the weapon that the player object 102 is equipped with. However, the types of attack may be set in advance, and do not need to be increased and changed.

Moreover, recovery A, recovery B, recovery C, and - - - are displayed in the selection screen 110. However, there may be one type of recovery or two or more. The types of recovery are increased as the player object 102 learns recoveries, and also increased or changed depending on the item that the player object 102 possesses or uses. However, the types of recovery may be set in advance, and do not need to be increased and changed.

A predetermined effect may be obtained when the player object 102 attacks the enemy object 104 or the player object 102 executes a recovery of an HP. However, in making the player object 102 attack the enemy object 104, by using the input device 30, the player selects one of the commands, the attack A, the attack B, the attack C, and - - - that are being displayed in the selection screen 110, and determines execution of the selected command. Then, an attack according to the executed command is performed. Moreover, in making the player object 102 recover the HP, by using the input device 30, the player selects one of the commands, the recovery A, the recovery B, the recovery C, and - - - that are being displayed in the selection screen 110, and determines execution of the selected command. Then, a recovery according to the executed command is performed.

Specifically, when the player object 102 attacks the enemy object 104, the HP of the enemy object 104 is decreased by a value according to the type of attack (hereinafter, referred to as “standard value”). However, if the attack of the player object 102 does not hit the enemy object 104 or the attack of the player object 102 does not work on the enemy object 104, the HP of the enemy object 104 may not be reduced.

Moreover, when the player object 102 performs the recovery of the HP, the HP of the player object 102 is recovered or increased by a value according to a type of recovery (hereinafter, referred to as “standard value”).

In the embodiment, when a command is executed by the player, during a time period that the player object 102 performs an action according to the command, it is judged on a timing associated in advance with the action whether a predetermined operation input by the player is performed. When it is judged that the predetermined operation input by the player is not performed on the above-described timing, a game situation of the virtual game is updated in a first manner, and when it is judged that the predetermined operation input by the player is performed on the above-described timing, the game situation of the virtual game is updated in a second manner that is different from the first manner.

In the embodiment, an animation of the action of the player object 102 according to the command is constituted of a plurality of frames (hereinafter, referred to as “animation frame”) so that the action is performed from an initial state. A range of predetermined animation frames (hereinafter, referred to as “success range”) is assigned to a part of the plurality of animation frames constituting the animation of the action of the player object 102. This success range is the timing associated in advance with the action of the player object 102. A frame is a unit time that updates a screen, and may be set as 1/30 seconds or 1/60 seconds as an example.

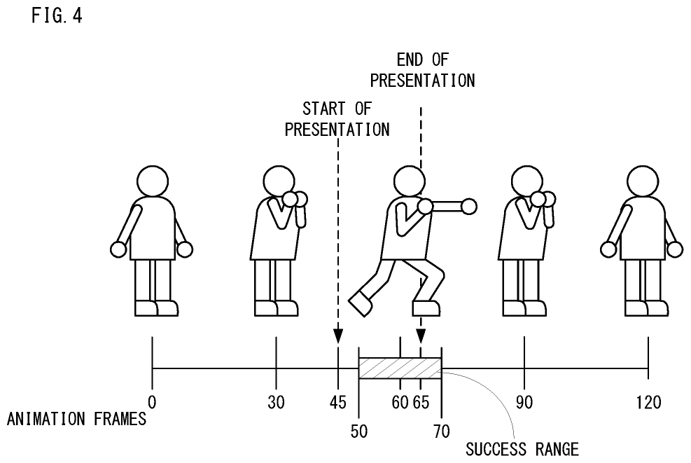

FIG. 4 is a view showing non-limiting example some animation frames in a case where the player object 102 executes a punching action. As shown in FIG. 4, the animation of the punching action is constituted by the animation frames of 120 (one hundred and twenty).

When the animation frame is the 0th frame, the player object 102 is in an upright state (i.e., initial state). When playing-back the animation frames of the punching action, as the animation frame increases in number of frames from the first frame, a posture of the player object 102 is changed into a stance posture before punching. When the animation frame is the 30th frame, the player object 102 becomes into a state where the player object 102 is holding a stance.

Subsequently, as the animation frame increases in number of frames from the 31st frame, the posture of the player object 102 is changed from the state of holding a stance to a posture where the player object 102 is punching. When the animation frame is the 60th frame, the player object 102 becomes in a state where the left hand is extended, i.e., in a state of punching with the left hand.

Furthermore, as the animation frame increases in number of frames from the 61st frame, the posture of the player object 102 is changed from a state where the left hand is extended to a state where the player object 102 is holding a stance. When the animation frame is the 90th animation frame, the player object 102 becomes into a state where the player object 102 is holding a stance.

Then, as the animation frame increases in number of frames from the 91st frame, the posture of the player object 102 is changed so that the player object 102 returns from a state of holding a stance to the initial state. When the animation frame is the 120th frame, the player object 102 becomes in the initial state, i.e., in the upright state.

As shown in FIG. 4, in the plurality of animation frames constituting the animation of the punching action, the success range of a predetermined number (here, 20) of frames centered on the 60th frame is set corresponding to the punching action.

When the player object 102 is executing a predetermined action corresponding to the command determined by the player, if a predetermined operation (in the embodiment, an operation of the A button) by the player is performed on a timing corresponding to the success range, the game situation of the virtual game is updated in a manner that is different from a manner that the predetermined operation by the player is not performed on the timing corresponding to the success range.

As an example, if an operation of the A button by the player is not performed on the timing corresponding to the success range during when the player object 102 is executing the punching action according to an attack command of punch, that is, when an operation of the A button by the player is failed, if a punch of the player object 102 hits the enemy object 104, a damage of a standard value regarding the punching action is inflicted on the enemy object 104. Specifically, the standard value regarding the punching action is subtracted from the HP of the enemy object 104. That is, when the player object 102 executes a punching action, the game situation of the virtual game is updated in a first manner.

On the other hand, when an operation of the A button by the player is performed on the timing corresponding to the success range during a time period that the player object 102 is executing the punching action according to an attack command of punch, that is, when an operation of the A button by the player is successful, if a punch of the player object 102 hits the enemy object 104, a damage that the standard value regarding the punching action is corrected is inflicted on the enemy object 104. Specifically, a standard value that is corrected by adding a first correction value to the standard value regarding the punching action is subtracted from the HP of the enemy object 104. Therefore, when an operation of the A button by the player is successful, a more serious damage than a case where an operation of the A button by the player is failed is inflicted on the enemy object 104. That is, when the player object 102 executes a punching action, the game situation of the virtual game is updated in a second manner different from the first manner.

However, instead of correcting the standard value that reduces the HP of the enemy object 104 when an operation of the A button is successful, a damage inflicted on the enemy object 104 may be made to be increased resultantly by correcting a critical rate of an attack of the player object 102.

This is an example, and instead of increasing the damage inflicted on the enemy object, or in addition to increasing the damage inflicted on the enemy object, a range of inflicting a damage, i.e., a range of an attack may be made larger. For example, when the player object 102 is playing a match against a plurality of enemy objects 104, by inflicting damages to one enemy object 104 and one or more enemy objects 104 next to this one enemy object 104, or by inflicting damages to all enemy objects 104 on the field, it is possible to make a range of inflicting the damage larger.

Moreover, in another example, instead of increasing the damage inflicted on the enemy object, or in addition to increasing the damage inflicted on the enemy object, an amount by which a status such as an ability value of the player object 102 is increased (i.e., amount of buff) may be increased, or the number of statuses to be buffed may be increased.

A punch is an example, and the same applies to further attacks such as kick. The further attacks include an attack using weapons and/or an attack using magic. In a case of attacks using weapons, the success range is set in accordance with an action of the player object 102 when using weapons such as swords, spears, whips and guns. In a case of a magic attack, the success range is set in accordance with an action of the player object 102 when using magic. However, the standard value is set individually for a plurality types of attack.

As another example, when an operation of the A button by the player is not performed on the timing corresponding to the success range during a time period that the player object 102 is executing a recovery action according to a recovery command, that is, when an operation of the A button by the player is failed, the HP of the player object 102 is recovered by a value determined by a standard value regarding a recovery action (hereinafter, referred to as “recovery value”). That is, when the player object 102 executes a recovery action, the game situation of the virtual game is updated in a first manner.

On the other hand, when an operation of the A button by the player is performed on the timing corresponding to the success range during a time period that the player object 102 is executing a recovery action according to a recovery command, that is, when an operation of the A button by the player is successful, the HP of the player object 102 is recovered by a recovery value determined by a standard value that is corrected. Specifically, the recovery value by which the HP of the player object 102 is recovered is made larger by adding a second predetermined correction value to the standard value. Therefore, when an operation of the A button by the player is successful, the HP of the player object 102 is recovered with a larger recovery value than a case where an operation of the A button by the player is failed. That is, when the player object 102 performs the recovery action, the game situation of the virtual game is updated with a second manner different from the first manner. The second correction value may be same value as the first correction value or a different value from the first correction value. However, there are a plurality of types of recovery, and the standard value is set individually for the plurality of types of recovery.

Thus, if a predetermined operation by the player (in the embodiment, the operation of the A button) is performed on the timing corresponding to the success range when the player object 102 is executing the predetermined action corresponding to the command determined by the player, it is possible to update the game situation in favor of the player compared to a case where the operation of the A button by the player is not performed on a timing corresponding to the success range.

However, the game situation does not need to be updated in favor of the player. That is, the game situation should just be updated so that the game situation may become different manners between a case where an operation of the A button is successful and a case where an operation of the A button is failed.

As an example, if a predetermined operation by the player (in the embodiment, the operation of the A button) is performed on the timing corresponding to the success range when the player object 102 is executing the predetermined action corresponding to the command determined by the player, a predetermined sound effect may be output, in different from a case where an operation of the A button by the player is not performed on a timing corresponding to the success range.

Moreover, instead of outputting the predetermined sound effect, or in addition to outputting the predetermined sound effect, after a play-back of the animation of the action of the player object 102 corresponding to a command is ended, animations of an action of the player object 102 and/or an action of the enemy object 104 for directing that the operation of the A button is successful may be played-back.

However, different sound effects may be output dependent on whether the operation of the A button by the player is performed or not performed on the timing corresponding to the success range. Similarly, after a play-back of the animation of the action of the player object 102 corresponding to a command is ended, animations of an action of the player object 102 and/or an action of the enemy object 104 that are for performing different directions dependent on whether the operation of the A button by the player is performed or not performed on the timing corresponding to the success range may be played-back.

However, since an action of the player object 102 differ for each command, that is, an animation of an action of the player object 102 differs for each command, the numbers of animation frames constituting the animation differs for each command, and thus, there are cases where the position and length that the success range is set. The same applies to each action of the enemy object 104 and the success range corresponding to each action of the enemy object 104.

Here, although the above-described success range is set to the position that a developer et al. believe as a good timing to each of an action of the player object 102 corresponding to each command, an interpretation of the good timing is a different by people. Therefore, for a player that does not know when he/she should operate the A button during the action of the player object 102, if no cue or sign is issued, a specification that allows the virtual game to advance advantageously when the operation of the A button is successful may end up being an unreasonable specification. On the other hand, when a cue or sign is issued on a good timing for each time, there is a risk that it may be perceived as a task of simply operating the A button after seeing the cue, rather than measuring a timing by looking at the action of the player object 102.

Therefore, in the embodiment, a cue or guide for encouraging to perform an operation of the A button within the success range is presented for each action of the player object 102 corresponding to each command, and when the number of times that the player successfully operates the A button (hereinafter, referred to as “number of success times”) reaches a first predetermined number of times (in the embodiment, five times), a state is changed to a state not presenting the guide. That is, a guide presentation flag described later is turned off as the number of success times satisfies a change condition for changing from a state of presenting the guide to a state of not presenting the guide.

On the other hand, when the number of times that the player fails an operation of the A button (hereinafter, referred to as “number of failure times”) against an action of the player object 102 not presenting the guide reaches a second predetermined number of times (in the embodiment, five times), the state is changed to the state of presenting the guide. That is, the guide presentation flag is turned on as the number of failure times satisfies a change condition for changing from a state of not presenting the guide to a state of presenting the guide. Therefore, it is possible to suitably present the guide for each action of the player object 102 corresponding to each command, without spoiling the interest of the virtual game.

In addition, in the embodiment, the first predetermined number of times and the second predetermined number of times are set as the same number of times, but may be set as different number of times.

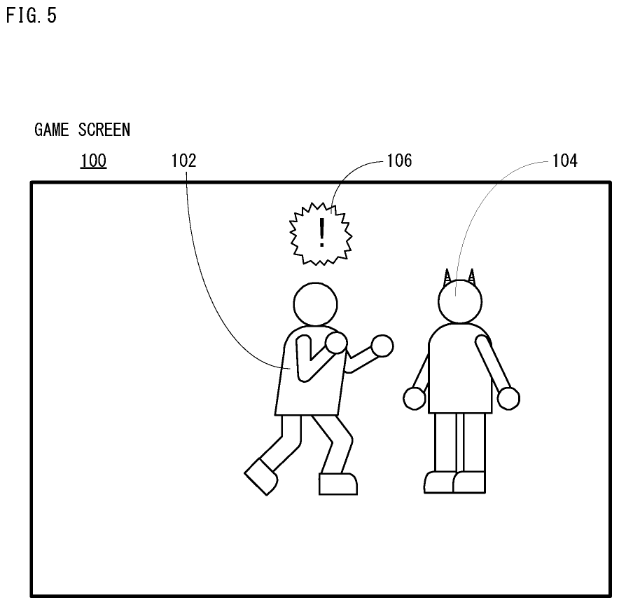

In the embodiment, when the player object 102 is executing the predetermined action corresponding to the command that is determined by the player, on the timing of the success range, the guide corresponding to the timing within the success range is presented. Specifically, a guide image 106 is displayed on a timing that is a first predetermined number of frames (in the embodiment, five frames) before a start timing in the success range, i.e., a start timing of presentation of the guide (see FIG. 5). That is, the display of the guide image 106 is started. In an example shown in FIG. 4, the start timing of the presentation of the guide (hereinafter, referred to as “presentation start timing”) is the 45th frame in the number of animation frames that is five frames before the 50th frame that is the start timing in the success range.

Since the guide image 106 is displayed in order to encourage the player to operate the A button within success range, the presentation start timing is set at a position that is neither too early nor too late than the start timing of the success range. However, since the success range has a certain amount of time period, the presentation start timing may be the same as the start timing of the success range. Moreover, in order to prevent the timing of an operation of the A button from exceeding the success range, the guide image 106 is erased on a timing that is a second predetermined number of frames (in the example, five frames) before an end of the success range, i.e., an end of the presentation of the guide (hereinafter, referred to as “presentation end timing”).

In addition, although the first predetermined number of frames and the second predetermined number of frames are set as the same number of frames in the embodiment, may be set as different number of times.

FIG. 5 is a view showing a non-limiting example game screen 100 that the guide image 106 is being displayed. As shown in FIG. 5, the guide image 106 is displayed above the player object 102. The guide image 106 is an image with an exclamation mark inside a jagged circle. This is an example, if a timing that the A button is to be operated can be presented, another image may be displayed, and the guide image 106 may be displayed on other positions except the above the player object 102. As shown also in FIG. 5, the guide image 106 is displayed when the player object 102 is in a state between a state of holding a stance and a punching state. That is, the presentation of a timing that the A button is to be operated is started. Although illustration is omitted, the guide image 106 is erased when the player object 102 begins to return from the punching state to the state of holding a stance.

Although the guide image 106 is displayed on the timing corresponding to the success range of the embodiment, instead of displaying the guide image 106 or in addition to displaying the guide image 106, a timing that the A button is to be operated may be presented with a predetermined sound.

Moreover, in a turn of an opponent, depending on the opponent, the enemy object 104 may attack the player object 102 or recover the HP of the enemy object 104. In this case, the player can defend the attack of the enemy object 104 on the player object 102, or can interfere with the recovery of the HP of the enemy object 104.

If the player object 102 defends the attack of the enemy object 104, even if the player object 102 receives the attack of the enemy object 104, a damage by the attack may be reduced. Therefore, as for the HP of the player object 102, an amount of the HP to be reduced is made lesser than a case where the attack of the enemy object 104 is not defended.

Moreover, if the player object 102 interferes with a recovery of the HP of the enemy object 104, even if the enemy object 104 executes a recovery of the HP, a recovery value of the HP to be recovered is reduced.

An animation of an action of the enemy object 104 is constituted with a plurality of animation frames as similar to the action of the player object 102. The above-described success range is associated in advance also with the action of the enemy object 104. Therefore, a predetermined operation by the player (in the embodiment, operation of the A button) is performed on a timing corresponding to the success range when the enemy object 104 is executing an action, the game situation of the virtual game is updated in a manner that is different from a manner when the operation of the A button by the player is not performed on a timing corresponding to the success range.

When an operation of the A button by the player is not performed on a timing corresponding to the success range during when the enemy object 104 is executing an attack action against the player object 102, that is, when an operation of the A button by the player is failed, if the attack hits the player object 102, a damage of a standard value regarding the attack by the enemy object 104 is inflicted on the player object 102. Specifically, the standard value regarding the attack of the enemy object 104 is subtracted from the HP of the player object 102. That is, when the enemy object 104 attacks the player object 102, the game situation of the virtual game is updated in a first manner.

On the other hand, when an operation of the A button by the player is performed on a timing corresponding to the success range during a time period that the enemy object 104 is executing an attack action against the player object 102, that is, when an operation of the A button by the player is successful, if the player object 102 defends the attack of the enemy object 104, a damage that the standard value regarding the attack is corrected is inflicted on the player object 102. Specifically, a standard value that is corrected by adding a third correction value to the standard value regarding the attack of the enemy object 104 is subtracted from the HP of the player object 102. Therefore, when an operation of the A button by the player is successful, a smaller damage than that of a case where an operation of the A button by the player is failed is inflicted on the player object 102. That is, when the player object 102 executes a defending action, the game situation of the virtual game is updated in a second manner different from the first manner. The third correction value may be same value as the first correction value and the second correction value, or a different value from the first correction value and the second correction value. However, there are a plurality of types of attacks of the enemy object 104, and the standard value is set individually for the plurality of types of attacks.

When an operation of the A button by the player is not performed on a timing corresponding to the success range during a time period that the enemy object 104 is executing an action of recovery, that is, when an operation of the A button by the player is failed, the HP of the enemy object 104 is recovered by a recovery value determined by the standard value regarding the action of recovery. That is, when the enemy object 104 performs an action of recovery, the game situation of the virtual game is updated with a first manner.

On the other hand, when an operation of the A button by the player is performed on a timing corresponding to the success range during a time period that the enemy object 104 is executing an action of recovery, that is, when an operation of the A button by the player is successful, the HP of the enemy object 104 is recovered by a recovery value determined by the standard value that is corrected. Specifically, the recovery value that the HP of the enemy object 104 is recovered is made smaller by subtracting a fourth predetermined correction value from the standard value. Therefore, when an operation of the A button by the player is successful, the HP of the enemy object 104 is recovered by a smaller recovery value than that of a case where an operation of the A button by the player is failed. That is, when the enemy object 104 performs an action of recovery, the game situation of the virtual game is updated with a second manner different from the first manner. The fourth correction value may be the same value as the first correction value, the second correction value and the third correction value, or may be a different value. However, there are a plurality of types of recovery actions of the enemy object 104, and the standard value is set individually for the plurality of types of recovery actions.

Thus, if a predetermined operation by the player (in the embodiment, operation of the A button) is performed on a timing corresponding to the success range when the enemy object 104 is executing an action, it is possible to update the game situation in favor of the player compared to a case where the operation of the A button by the player is not performed on a timing corresponding to the success range.

However, as similar to a case where the player object 102 performs an attack or a recovery, in also a case where the enemy object 104 performs an attack or a recovery, the game situation does not need to be updated in favor of the player. That is, the game situation should just be updated so that different results may be brought between a case where an operation of the A button is successful and a case where an operation of the A button is failed.

As an example, if a predetermined operation by the player (in the embodiment, operation of the A button) is performed on a timing corresponding to the success range when the enemy object 104 is executing an attack or a recovery, a predetermined sound effect may be output, in different from a case where an operation of the A button by the player is not performed on a timing corresponding to the success range. Instead of outputting the predetermined sound effect, or in addition to outputting the predetermined sound effect, after a play-back of the animation of the action of the attack or recovery of the enemy object 104, animations of an action of the player object 102 and/or an action of the enemy object 104 that are for directing that the operation of the A button is successful may be played-back.

However, different sound effects may be output dependent on whether an operation of the A button by the player is performed or not performed on a timing corresponding to the success range. Similarly, after a play-back of the animation of the attack or recovery of the enemy object 104, animations of an action of the player object 102 and/or an action of the enemy object 104 that are for performing different directions dependent of whether an operation of the A button by the player is performed or not performed on a timing corresponding to the success range may be played-back.

Moreover, when the enemy object 104 is executing an action of an attack or a recovery, the guide image 106 is displayed so as to encourage the player to perform an operation of the A button within the success range.

In the embodiment, the cue or guide for encouraging the player to perform an operation of the A button within the success range is presented for each action of the enemy object 104, and the number of success times that the player is successful in the operate the A button reaches a third predetermined times (in the embodiment, five times), the state is changed to a state not presenting the guide. That is, the guide presentation flag is turned off as the number of success times satisfies a change condition for changing from a state of presenting the guide to a state of not presenting the guide.

On the other hand, when the number of failure times that the player fails an operation of the A button against an action of the player object 102 that the guide is not presented reaches a fourth predetermined number of times (in the embodiment, five times), the state is changed to the state of presenting the guide. That is, the guide presentation flag is turned on as the number of failure times satisfies a change condition for changing from a state of not presenting the guide to a state of presenting the guide. Therefore, it is possible to suitably present the guide for each action of the enemy object 104, without spoiling the interest of the virtual game.

In addition, although the third predetermined number of times and the fourth predetermined number of times are set as the same number of times in the embodiment, may be set as different number of times. Moreover, the third predetermined number of times may be the same as the first predetermined number of times, or may be different number of times. Furthermore, the fourth predetermined number of times may be the same as the second predetermined number of times, or may be different number of times.

Although illustration is omitted, during a time period that the enemy object 104 is executing the predetermined action determined by a computer, the guide image 106 is displayed as shown in FIG. 5 on the start timing of presentation before the third predetermined frame number of the start timing of the success range (in the embodiment, five frames). Moreover, the guide image 106 is erased on the presentation end timing that is a fourth predetermined number of frames (in the embodiment, five frames) before the end timing of the success range.

In addition, although the third predetermined number of frames and the fourth predetermined number of frames are set as the same number of frames in the embodiment, may be set as different number of times. Moreover, the third predetermined number of frames may be the same as first predetermined frame number, or a different number of frames. Furthermore, the fourth predetermined number of frames may be the same as second predetermined frame number, or a different number of frames.

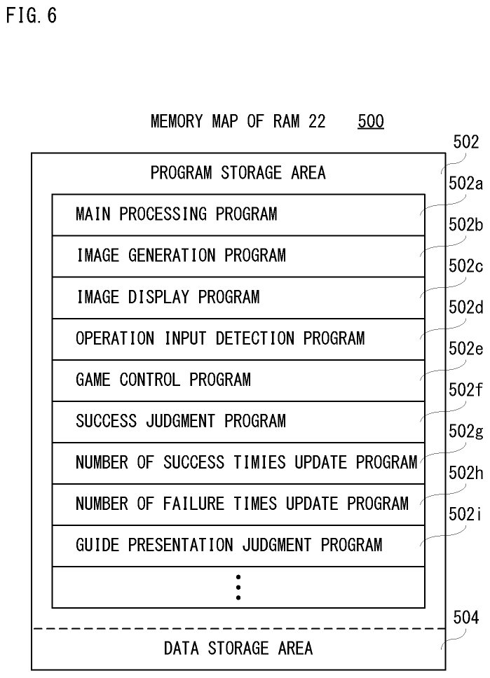

FIG. 6 is a view showing a non-limiting example memory map 500 of the RAM 22 of the game apparatus 10 shown in FIG. 2. As shown in FIG. 6, the RAM 22 includes a program storage area 502 and a data storage area 504. The program storage area 502 is stored with an application program of a virtual game (i.e., game program) according to this embodiment, which is an example of an information processing program. The game program includes a main processing program 502a, an image generation program 502b, an image display program 502c, an operation input detection program 502d, a game control program 502e, a success judgment program 502f, a number of success times update program 502g, a number of failure times update program 502h, a guide presentation determination program 502i, etc.

In addition, the information processing program may be stored in advance in the flash memory 24, or may be acquired from an external server or another game apparatus 10 via a network such as Internet. Moreover, the information processing program may be acquired from an external memory attachable to or detachable from the game apparatus 10, such an optical disk, a USB memory or a memory card. However, a part of the information processing program is stored in the flash memory 24, and other parts thereof may be acquired from the external server, other game apparatus 10 or the external memory. These also apply to the image generation data 504b described later.

The main processing program 502a is a program for processing a main routine of the game program of the embodiment. The image generation program 502b is a program for generating, using the image generation data 504b, game image data corresponding to various kinds of screens or images. The image display program 502c is a program for outputting the game image data generated according to the image generation program 502b to the display device 36. Therefore, various kinds of screens, such as the game screen 100 are displayed on the display device 36.

The operation input detection program 502d is a program for detecting operation input data 504a with respect to an operation input portion by the player. In the embodiment, the operation input portion includes various kinds of push buttons, keys or switches provided on the input device 30.

The game control program 502e is a program for executing game control processing of the virtual game of the embodiment.

The success judgment program 502f is a program for judging, during a time period that the player object 102 is executing a predetermined action corresponding to the command determined by the payer, or during a time period that the enemy object 104 is executing an action of the attack or the recovery, whether a predetermined button (in the embodiment, A button) is operated by the player within the success range that is set in advance with respect to the action being executed, i.e., whether the operation of the predetermined button is successful.

The number of success times update program 502g is a program for incrementing, when the operation of the predetermined button is judged to be successful according to the success judgment program 502f in a state that the guide image 106 is presented regarding the action being executed by the player object 102 or the action being executed by the enemy object 104, the number of success times regarding the action being executed by one (1).

The number of failure times update program 502h is a program for incrementing, when the operation of the predetermined button is judged is not to be successful (i.e., failed) according to the success judgment program 502f in a state that the guide image 106 is presented regarding the action being executed by the player object 102 or the action being executed by the enemy object 104, the number of failure times regarding the action being executed by one (1).

The guide presentation determination program 502i is a program for determining whether the guide image 106 is to be presented for the action that the player object 102 is executing or the action that the enemy object 104 is executing.

Although illustration is omitted, the program storage area 502 is stored with other programs, such as a communication program for communicating with the server or other game apparatuses 10, a sound output program for generating and outputting a sound required in the virtual game, a program for changing a direction of the virtual camera according to the operation input by the player, etc.

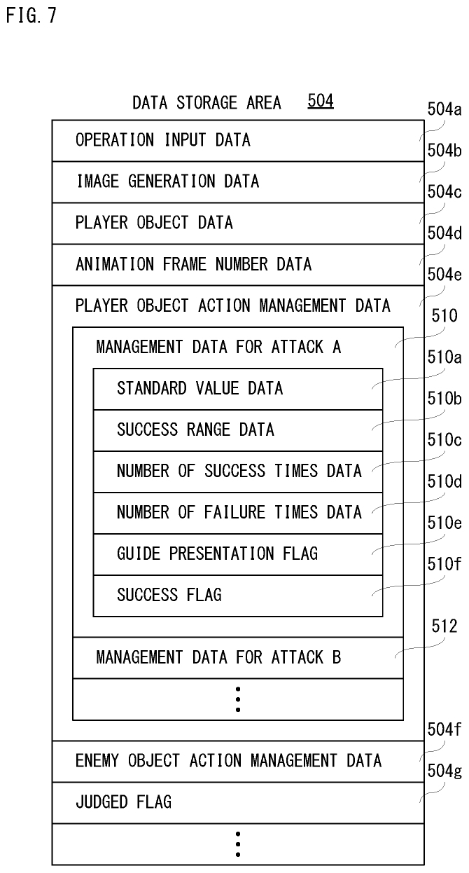

FIG. 7 is a view showing non-limiting example specific contents of the data storage area 504 of the RAM 22 shown in FIG. 6. As shown in FIG. 7, the data storage area 504 is stored with the operation input data 504a, the image generation data 504b, player object data 504c, animation frame number data 504d, player object action management data 504e, enemy object action management data 504f, a judged flag 504g, etc.

The operation input data 504a is data that is input from the input device 30, and is stored according to a time series. The operation input data 504a is eliminated if used for processing by the processor 20.

The image generation data 504b includes data for generating the data of various kinds of screens, i.e., game image data, such as polygon data and texture data, etc.

The player object data 504c is data regarding the player object 102 in the virtual game, and is updated by the game control processing. As an example, the player object data 504c is data of parameters, such as a three-dimensional position of the player object 102 in the virtual space, the HP, kinds of items being possessed and the number of items being possessed.

The animation frame number data 504d is data indicating the number of current frame in the animation frames regarding the action of the attack or the recovery being executed by the player object 102 or the number of current frame in the animation frames regarding the action of the attack or the recovery being executed by the enemy object 104.

The player object action management data 504e includes management data of respective actions corresponding to respective commands that instruct various kinds of actions of the player object 102. The management data of respective actions includes standard value data, success range data, number of success times data, number of failure times data, a guide presentation flag and a success flag. Specifically, the player object action management data 504e includes management data 510 for the attack A, management data 512 for the attack B, and - - - . The management data 510 of the attack A includes standard value data 510a, success range data 510b, number of success times data 510c, number of failure times data 510d, a guide presentation flag 510e, and a success flag 510f.

The standard value data 510a is data regarding a standard value of the damage that is inflicted on the enemy object 104, i.e., a standard value by which the HP of the enemy object 104 is reduced, when the player object 102 performs an action corresponding to the attack A and the attack A hits the enemy object 104.

The success range data 510b is data regarding a range of the animation frames, i.e., the success range for judging whether the operation of the A button by the player is performed on a timing that is set in advance during a time period that the player object 102 performs corresponding to the attack A.

The number of success times data 510c is data regarding the number of times that the A button is operated by the player in the success range during a time period that the action of the player object 102 corresponding to the attack A is being executed when the guide presentation flag 510e described later is turned on.

The number of failure times data 510d is data regarding the number of times that the A button is not operated by the player in the success range during a time period that the action of the player object 102 corresponding to the attack A is being executed when the guide presentation flag 510e is turned off.

The guide presentation flag 510e is flag data for determining whether it is in a state that a cue indicating a timing of an operation of the A button is to be presented, i.e., in a state the guide image 106 is to be displayed, when the player object 102 is performing the action corresponding to the attack A. When it is in a state that the guide image 106 is to be displayed during the execution of an action of the player object 102 corresponding to the attack A, the guide presentation flag 510e is turned on. On the other hand, when it is in a state that the guide image 106 is not to be displayed during the execution of an action of the player object 102 corresponding to the attack A, the guide presentation flag 510e is turned off.

The success flag 510f is flag data for determining whether the player operated the A button in the success range during the execution of the action of the player object 102 corresponding to the attack A. The success flag 510f is turned on if the player operated the A button in the success range during the execution of the action of the player object 102 corresponding to the attack A. On the other hand, the success flag 510f is turned off if the player did not operate the A button in the success range during the execution of the action of the player object 102 corresponding to the attack A.

Although illustration and detailed description are omitted, the above-described management data is similarly applied to the management data 512 of the attack B and the management data for the actions of the player object 102 corresponding to the other commands. Thus, it is managed for each action of the player object 102 corresponding to each command whether it is in a state of presenting the guide image 106.

However, when a command corresponds to an action of the recovery of the player object 102, the standard value data is data regarding a standard value for determining a recovery value by which the HP of the player object 102 is recovered.

The enemy object action management data 504f includes management data of respective actions of the enemy object 104, and is similar to the management data of respective actions of the player object 102. The enemy object action management data 504f also includes, as similar to the player object action management data 504f, management data of respective actions and respective recoveries of the enemy object 104, and the management data of respective actions and respective recoveries includes standard value data, success range data, number of success times data, number of failure times data, a guide presentation flag and a success flag.

However, the standard value data is data regarding a damage inflicted on the player object 102 if the enemy object 104 attacks the player object 102 in a case of the action of attack of the enemy object 104. Moreover, the standard value data is data regarding a standard value for determining a recovery value by which the HP of the enemy object 104 is to be recovered in a case of the recovery action of the enemy object 104. The success range data, the number of success times data, the number of failure times data, the guide presentation flag and the success flag are the same as those of the player object action management data 504e.

The judged flag 504g is flag data for determining whether the player operated the A button within the success range during execution of an action of the player object 102 corresponding to the command determined by the player, or during execution of an action of the enemy object 104. The judged flag 504g is turned on when it is judged that the player operated the A button within the success range during the execution of an action of the player object 102 corresponding to the command determined by the player, or during the execution of an action of the enemy object 104. On the other hand, the judged flag 504g is turned off when it is not judged that the player operated the A button within the success range during the execution of an action of the player object 102 corresponding to the command determined by the player, or during the execution of an action of the enemy object 104.

Although illustration is omitted, the data storage area 504 is stored with other data required for the information processing of the virtual game, and is provided with a counter(s) or a timer(s). For example, data of a position and a direction of respective non-player objects in the virtual space, such as the enemy object, respective background objects and the virtual camera, etc. are also stored.

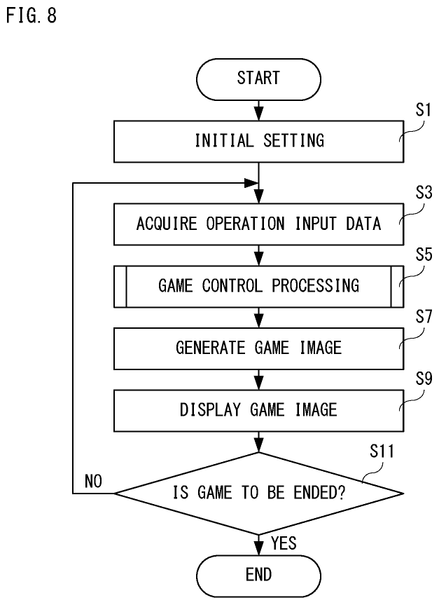

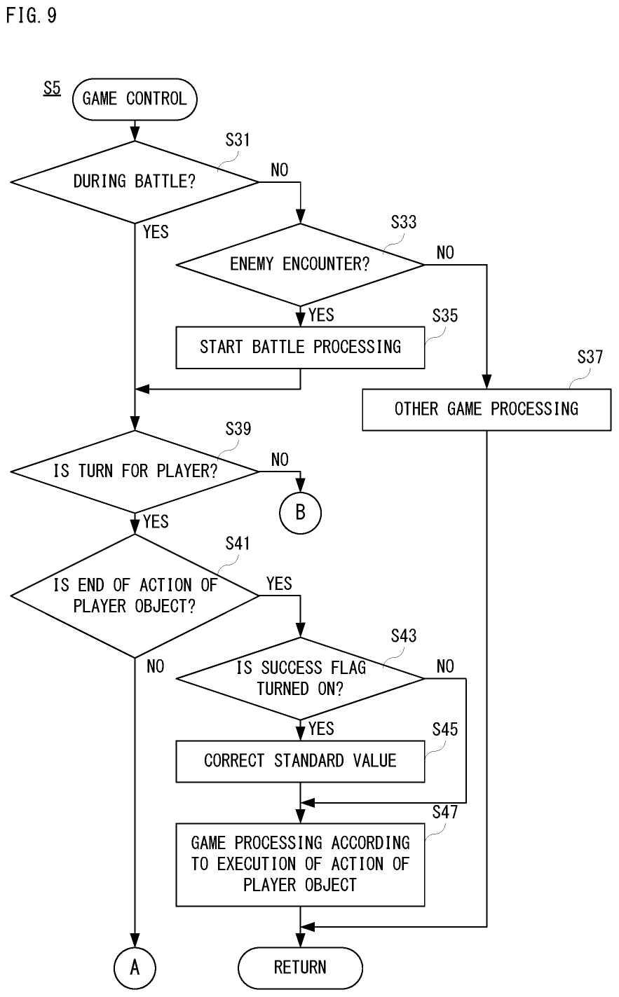

FIG. 8 is a flowchart showing non-limiting example overall processing of the game program by the processor 20 shown in FIG. 1. FIG. 9-FIG. 13 are flowcharts showing non-limiting example game control processing by the processor 20 shown in FIG. 1.

However, processing of respective steps of the flowcharts shown in FIG. 8-FIG. 13 are mere examples, and if the same or similar result is obtainable, an order of the respective steps may be exchanged. Moreover, in the embodiment, it will be described that the processing of the respective steps of the flowcharts shown in FIG. 8-FIG. 13 are basically executed by the processor 20; however, some steps may be executed by a processor(s) and/or a dedicated circuit(s) other than the processor 20.

In the following, the overall processing and game control processing will be described with reference to FIG. 8-FIG. 13, but duplicated descriptions will be omitted on the same content of processing.

When the power supply of the game apparatus 10 is turned on, prior to execution of the overall processing, the processor 20 executes a boot program stored in a boot ROM not shown, whereby respective units including the RAM 22, etc. are initialized. The game apparatus 10 will start the overall processing if execution of the game program according to the embodiment is instructed by the player.

As shown in FIG. 8, if the overall processing is started, the processor 20 executes initial setting in a step S1. Here, the processor 20 determines positions and directions that the player object 102, respective non-player objects (including the enemy object 104), respective background objects and the virtual camera are to be arranged to initial positions and initial directions, in the virtual space.

However, when the virtual game is started from the continuation last time, the processor 20 determines the positions and the directions that the player object 102, the respective non-player objects, the respective background objects and the virtual camera are to be arranged to positions and directions at a time of saving, in the virtual space.

Therefore, the player object data 504c that the data of the initial position and the initial direction or the data of the position and the direction at the time of saving of the player object 102 are set as current position data and current direction data is stored in the data storage area 504. Similarly, the data that the data of the initial position and the initial direction or the data of the position and the direction at the saved point of the respective non-player objects, the respective background objects and the virtual camera in the virtual space are set as current position data and current direction data is stored in the data storage area 504.

In a subsequent step S3, the operation input data transmitted or input from the input device 30 is acquired, and in a step S5, the game control processing (see FIG. 9-FIG. 12) described later is executed. In a next step S7, the game image is generated. In the step S7, the processor 20 generates the game image data regarding the game screen 100 based on a result of the game control processing in the step S5.

In a next step S9, the game image is displayed. Here, the processor 20 outputs the game image data generated in the step S7 to the display device 36 through the display control circuit 32.

Then, in a step S11, it is determined whether the virtual game is to be ended. Determination in the step S11 is made on whether the player performs an instruction to end the virtual game, or the like. If “NO” is determined in the step S11, that is, the virtual game is not to be ended, the process returns to the step S3. On the other hand, if “YES” is determined in the step S11, that is, if the virtual game is to be ended, the overall processing is terminated.

As shown in FIG. 9, if staring the game control processing, in a step S31, the processor 20 determines whether it is during a battle. If “YES” is determined in the step S31, that is, if it is during a battle, the process proceeds to a step S39. On the other hand, if “NO” is determined in the step S31, that is, if it is not during a battle, it is determined, in a step S33, whether the player object 102 encountered the enemy object 104.

If “YES” is determined in the step S33, that is, the player object 102 encountered the enemy object 104, in a step S35, battle processing is started, and then, the process proceeds to the step S39. On the other hand, if “NO” is determined in the step S33, that is, the player object 102 did not encounter the enemy object 104, other game processing is executed in a step S37, and the process returns to the overall processing. In the step S37, the processor 20 executes processing other than the battle, such as making the player object 102 move according to an operation of the player or automatically, or making the enemy object 104 move, making the item be arranged, making the player object 102 acquire an item, etc.

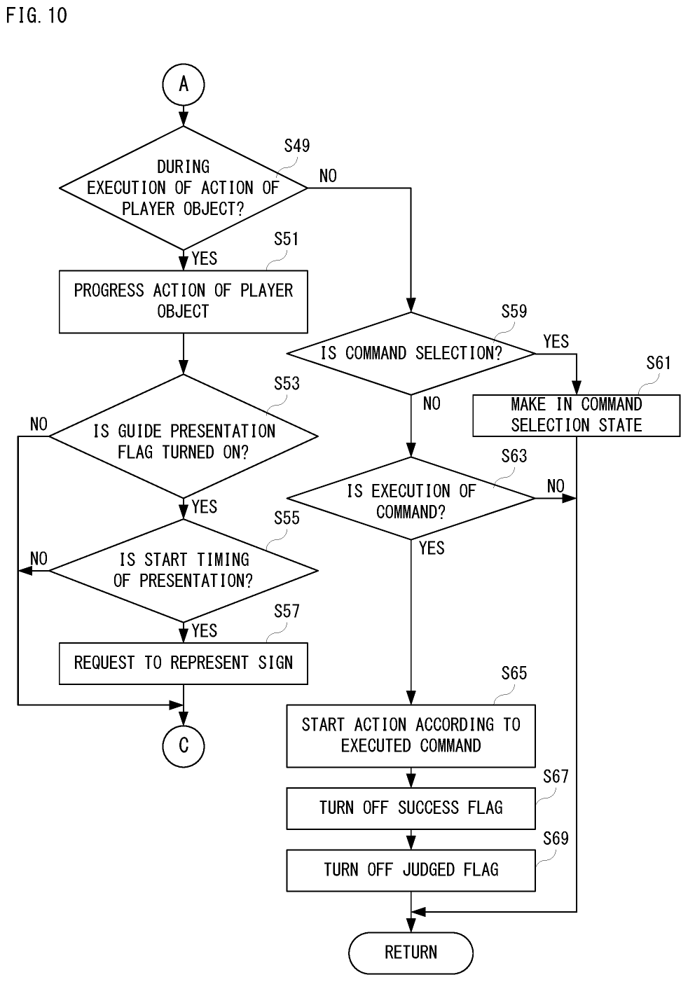

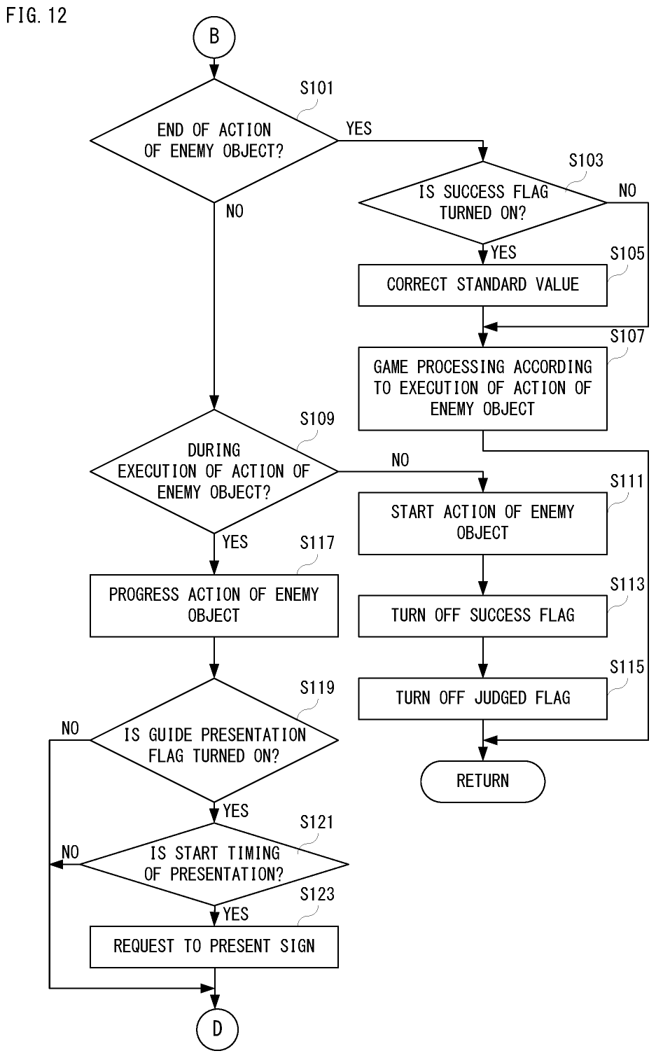

In the step S39, it is determined whether it is a turn of the player. If “NO” is determined in the step S39, that is, if it is a turn of an opponent, the process proceeds to a step S101 shown in FIG. 12. On the other hand, if “YES” is determined in the step S39, that is, if it is a turn of the player, it is determined, in a step S41, whether it is an end of an action of the player object 102. If “NO” is determined in the step S41, that is, if it is not an end of an action of the player object 102, the process proceeds to a step S49 shown in FIG. 10.

On the other hand, if “YES” is determined in the step S41, that is, if it is an end of an action of the player object 102, it is determined, in a step S43, whether the success flag regarding this action of the player object 102 is turned on. If “NO” is determined in the step S43, that is, if the success flag regarding this action of the player object 102 is turned off, the process proceeds to a step S47. On the other hand, if “YES” is determined in the step S43, that is, if the success flag regarding this action of the player object 102 is turned on, in a step S45, the standard value regarding the action that the player object 102 performed is corrected, and then, the process proceeds to a step S47. In the embodiment, in the step S45, the processor 20 increases the standard value of the damage that the player object 102 inflicts on the enemy object 104, or increases the standard value of the recovery value that recovers the HP of the player object 102.

In the step S47, the game processing according to the execution of the action of the player object 102 is executed, and the process returns to the overall processing. At this time, the processor 20 ends the turn of the player and makes it the turn of the opponent. In this step S47, when the attack of the player object 102 hits the enemy object 104, processing that reduces the HP of the enemy object 104 is executed. When the player object 102 performs the recovery, processing that increases the HP of the player object 102 is executed. However, when the processing of step S45 is executed, using the corrected standard value, the processor 20 decreases by attack the HP of the enemy object 104, or increases by the recovery the HP of the player object 102.

As shown in FIG. 10, in the step S49, it is determined whether it is during execution of an action of the player object 102. If “YES” is determined in the step S49, that is, if it is during execution of an action of the player object 102, the action of the player object 102 is progressed in a step S51. Here, the animation frame regarding the action that is being executed by the player object 102 is progressed by one (1) frame. At this time, the animation frame number indicated by the animation frame number data 504d is incremented by one (1).

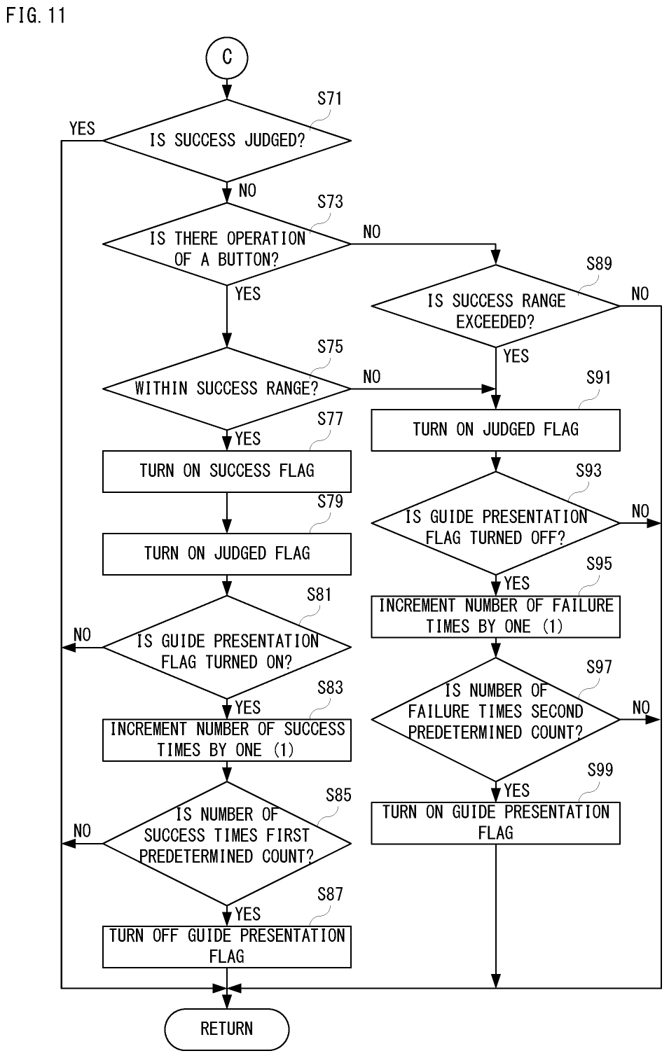

In a next step S53, it is determined whether the guide presentation flag regarding the action that the player object 102 is executing is turned on. If “NO” is determined in the step S53, that is, if the guide presentation flag regarding the action that the player object 102 is executing is turned off, the process proceeds to a step S71 shown in FIG. 11. However, an end of the cue is requested if it is during the display of the guide image 106. Therefore, if the end of the cue is requested, after returning to the overall processing, the game image data regarding the game screen 100 that the guide image 106 is erased is generated and output.

On the other hand, if “YES” is determined in the step S53, that is, if the guide presentation flag regarding the action that the player object 102 is executing is turned on, it is determined, in a step S55, whether it is a start timing of presentation. Here, the processor 20 determines whether the animation frame number indicated by the animation frame number data 504d is the first predetermined number of frames (e.g., five frames) before the start timing of the success range corresponding to the action that the player object 102 is executing.

If “NO” is determined in the step S55, that is, if it is not the start timing of presentation, the process proceeds to the step S71. On the other hand, if “YES” is determined in the step S55, that is, if it is the start timing of presentation, in a step S57, presentation of the cue is requested, and then, the process proceeds to the step S71. Therefore, if the processing of the step S57 is executed, after returning to the overall processing, the game image data regarding the game screen 100 including the guide image 106 is generated and output. However, the guide presentation flag regarding the action that the player object 102 is executing is turned off on the presentation end timing before the second predetermined number of frames (e.g., five frames) of the end timing of the success range corresponding to the action.

On the other hand, if “NO” is determined in the step S49, that is, if it is not during execution of an action of the player object 102, it is determined, in a step S59, whether it is selection of a command. If “YES” is determined in the step S59, that is, if it is selection of a command, in a step S61, a command that is selected is made to be in a selected state, and then, the process returns to the overall processing. On the other hand, if “NO” is determined in the step S59, that is, if it is not selection of a command, it is determined, in a step S63, whether it is execution of a command. Here, the processor 20 determines whether execution of the selected command is determined by the operation input of the player.

If “NO” is determined in the step S63, that is, if it is not execution of a command, the process returns to overall processing. On the other hand, if “YES” is determined in the step S63, that is, if it is execution of a command, in a step S65, the processor 20 makes the player object 102 start an action according to the executed command. At this time, the animation frame number data 504d is reset. That is, the number of animation frames is set as 0 (zero). In a next step S67, the success flag regarding the action of the player object 102 that is started in the step S65, and in a step S69, the judged flag 504g is turned off, and then, the process returns to the overall processing.

As shown in FIG. 11, in the step S71, it is determined whether a success has been judged. Here, the processor 20 determines whether the judged flag 504g is turned on. If “YES” is determined in the step S71, that is, if a success has been judge, the process returns to the overall processing. On the other hand, if “NO” is determined in the step S71, that is, if a success has not been judged, it is determined, in a step S73, whether there is an operation of the A button.

If “YES” is determined in the step S73, that is, if there is an operation of the A button, it is determined, in a step S75, whether a timing that the A button is operated is within the success range. Here, the processor 20 determines whether the animation frame number that is indicated by the animation frame number data 504d is within the success range corresponding to the action that the player object 102 is executing.

If “NO” is determined in the step S75, that is, if the timing that the A button is operated is outside the success range, the process proceeds to a step S91. On the other hand, if “YES” is determined in the step S75, that is, if the timing that the A button is operated is within the success range, the success flag regarding the action that the player object 102 is executing is turned on in a step S77, and the judged flag 504g is turned on in a step S79.

In a subsequent step S81, it is determined whether the guide presentation flag regarding the action that the player object 102 is executing is turned on. If “NO” is determined in the step S81, that is, if the guide presentation flag regarding the action that the player object 102 is executing is turned off, the process returns to the overall processing.

On the other hand, if “YES” is determined in the step S81, that is, if the guide presentation flag regarding the action that the player object 102 is executing is turned on, the number of success times regarding the action that the player object 102 is executing is incremented by one (1) in a step S83, and in a step S85, it is determined whether the number of success times regarding the action that the player object 102 is executing is the first predetermined number of success times (in the embodiment, five (5) times).

If “NO” is determined in the step S85, that is, if the number of success times regarding the action that the player object 102 is executing is not the first predetermined number of success times, the process returns to the overall processing. On the other hand, if “YES” is determined in the step S85, that is, if the number of success times regarding the action the player object 102 is executing is the first predetermined number of success times, in a step S87, the guide presentation flag regarding the action that the player object 102 is executing is turned off, and then, the process returns to the overall processing. At this time, the number of failure times regarding the action that the player object 102 is executing is reset.

Moreover, if “NO” is determined in the step S73, that is, if there is no operation of the A button, it is determined, in a step S89, whether the animation frame number exceeds the success range regarding the action that the player object 102 is executing. If “NO” is determined in the step S89, that is, the animation frame number does not exceed the success range, the process returns to the overall processing. On the other hand, if “YES” is determined in the step S89, that is, if the animation frame number exceeds the success range, the judged flag 504g is turned on in a step S91, and in a step S93, it is determined whether the guide presentation flag regarding the action that the player object 102 is executing is turned off.

If “NO” is determined in the step S93, that is, if the guide presentation flag regarding the action that the player object 102 is executing is turned on, the process returns to the overall processing. On the other hand, if “YES” is determined in the step S93, that is, if the guide presentation flag regarding the action that the player object 102 is executing is turned off, in a step S95, the number of failure times regarding the action that the player object 102 is executing is incremented by one (1), and it is determined, in a step S97, whether the number of failure times regarding the action that the player object 102 is executing is the second predetermined number (in the embodiment, five times).

If “NO” is determined in the step S97, that is, if the number of failure times regarding the action that the player object 102 is executing is not the second predetermined number of times, the process returns to the overall processing. On the other hand, if “YES” is determined in the step S97, that is, if the number of failure times regarding the action that the player object 102 is executing is the second predetermined number of times, in a step S99, the guide presentation flag regarding the action that the player object 102 is executing is turned on, and then, the process returns to the overall processing. At this time, the number of success times of regarding the action that the player object 102 is executing is reset.

As described above, if it is a turn of the opponent and “NO” is determined in the step S39, it is determined whether it is an end of the action of the enemy object 104 in the step S101 shown in FIG. 12. If “YES” is determined in the step S101, that is, if it is an end of the action of the enemy object 104, it is determined, in a step S103, whether the success flag regarding this action of the enemy object 104 is turned on.

If “NO” is determined in the step S103, that is, if the success flag regarding this action of the enemy object 104 is turned off, the process proceeds to a step S107. On the other hand, if “YES” is determined in the step S103, that is, if the success flag regarding this action of the enemy object 104 is turned on, in a step S105, the standard value regarding the action that the enemy object 104 performed is corrected, and then, the process proceeds to the step S107. In this embodiment, in the step S105, the processor 20 decreases the standard value for decreasing the standard value of the damage that the enemy object 104 inflicts on the player object 102, or for decreasing the recovery value that recovers the HP of the enemy object 104.

In the step S107, the game processing according to an execution of the action of the enemy object 104 is executed, and then, the process returns to the overall processing. At this time, the processor 20 ends the turn of the opponent and makes it a turn of the player. In this step S107, when the attack of the enemy object 104 hits the player object 102, processing for decreasing the HP of the player object 102 is executed. When the enemy object 104 performs the recovery, processing for increasing the HP of the enemy object 104 is executed. At this time, when the processing of the step S105 is executed, using the corrected standard value, the processor 20 decreases the HP of the player object 102, or increases the HP of the enemy object 104 by recovery.

On the other hand, if “NO” is determined in the step S101, that is, if it is not an end of the action of the enemy object 104, it is determined, in a step S109, whether it is during execution of an action of the enemy object 104. If “NO” is determined in the step S109, that is, if it is not during execution of an action of the enemy object 104, an action of the enemy object 104 is started in a step S111. In this step S111, an action of the enemy object 104 according to a command that is executed by a computer of the opponent, i.e., processor 20 is started. Moreover, the animation frame number data 504d is reset at this time.

In a next step S113, the success flag regarding the action of the enemy object 104 started in the step S111 is turned off, and in a step S115, the judged flag 504g is turned off, and then, the process returns to the overall processing.

On the other hand, if “YES” is determined in the step S109, that is, if it is during execution of an action of the enemy object 104, in a step S117, the action of the enemy object 104 is progressed, that is, the animation frame of the action is progressed by one (1) frame.

In a next step S119, it is determined whether the guide presentation flag regarding the action that the enemy object 104 is executing is turned on. If “NO” is determined in the step S119, that is, if the guide presentation flag regarding the action that the enemy object 104 is executing is turned off, the process proceeds to a step S125 shown in FIG. 13.

On the other hand, if “YES” is determined in the step S119, that is, if the guide presentation flag regarding the action that the enemy object 104 is executing is turned on, it is determined, in a step S121, whether it is the start timing of presentation. Here, the processor 20 determines whether the animation frame number indicated by the animation frame number data 504d is before the third predetermined frame number (e.g., five frames) of the start timing in the success range corresponding to the action that the enemy object 104 is executing.

If “NO” is determined in the step S121, that is, if it is not the start timing of presentation, the process proceeds to the step S125. However, an end of the cue is requested if it is during the display of the guide image 106. On the other hand, if “YES” is determined in the step S121, that is, if it is the start timing of presentation, the presentation of the cue is requested in a step S123, and the process proceeds to the step S125. However, the guide presentation flag regarding the action that the enemy object 104 is executing is turned off on the presentation end timing that is the fourth predetermined number of frames (e.g., five frames) before the end timing of the success range corresponding to the action.

As shown in FIG. 13, in the step S125, it is determined whether a success has been judged. If “YES” is determined in the step S125, the process returns to the overall processing. On the other hand, if “NO” is determined in the step S125, it is determined, in a step S127, whether there is an operation of the A button.

If “YES” is determined in the step S127, it is determined, in a step S129, whether the timing that the A button is operated is within the success range. Here, the processor 20 determines whether the animation frame number indicated by the animation frame number data 504d is within the success range corresponding to the action that the enemy object 104 is executing.

If “NO” is determined in the step S129, the process proceeds to a step S145. On the other hand, if “YES” is determined in the step S129, the success flag regarding the action the enemy object 104 is executing is turned on in a step S131, and the judged flag 504g is turned on in a step S133.

In a subsequent step S135, it is determined whether the guide presentation flag regarding the action that the enemy object 104 is executing is turned on. If “NO” is determined in the step S135, that is, if the guide presentation flag regarding the action that the enemy object 104 is executing is turned off, the process returns to the overall processing.

On the other hand, if “YES” is determined in the step S135, that is, if the guide presentation flag regarding the action that the enemy object 104 is executing is turned on, the number of success times regarding the action that the enemy object 104 is executing is incremented by one (1) in a step S137, and in a step S139, it is determined whether the number of success times regarding the action that the enemy object 104 is executing is the first predetermined number of times (in the embodiment, five times).

If “NO” is determined in the step S139, that is, if the number of success times regarding the action that the enemy object 104 is executing is not the first predetermined number of times, the process returns to the overall processing. On the other hand, if “YES” is determined in the step S139, that is, if the number of success times regarding the action that the enemy object 104 is executing is the first predetermined number of times, in a step S141, the guide presentation flag regarding the action that the enemy object 104 is executing is turned off, and the process returns to the overall processing. At this time, the number of failure times regarding the action that the enemy object 104 is executing is reset.

Moreover, if “NO” is determined in the step S127, it is determined, in a step S143, whether the animation frame number exceeds the success range regarding the action that the enemy object 104 is executing. If “NO” is determined in the step S143, that is, if the animation frame number does not exceed the success range, the process returns to the overall processing. On the other hand, if “YES” is determined in the step S143, that is, if the animation frame number exceeds the success range, the judged flag 504g is turned on in a step S145, and in a step S147, it is determined whether the guide presentation flag regarding the action that the enemy object 104 is executing is turned off.

If “NO” is determined in the step S147, that is, if the guide presentation flag regarding the action that the enemy object 104 is executing is turned on, the process returns to the overall processing. On the other hand, if “YES” is determined in the step S147, that is, if the guide presentation flag regarding the action that the enemy object 104 is executing is turned off, the number of failure times regarding the action that the enemy object 104 is executing is incremented by one (1) in a step S149, and in a step S151, it is determined whether the number of failure times regarding the action that the enemy object 104 is executing is the second predetermined number of times (in the embodiment, five times).

If “NO” is determined in the step S151, that is, if the number of failure times regarding the action that the enemy object 104 is executing is not the second predetermined number of times, the process returns to the overall processing. On the other hand, if “YES” is determined in the step S151, that is, if the number of failure times regarding the action that the enemy object 104 is executing is the second predetermined number of times, in a step S153, the guide presentation flag regarding the action that the enemy object 104 is executing is turned on, and the process returns to the overall processing. At this time, the number of success times regarding the action that the enemy object 104 is executing is reset.

According to the embodiment, since the cue is issued the predetermined frames before the success range that is set corresponding to the action that the player object is executing, it is possible to suitably present a timing that the predetermined button is to be operated. Moreover, since the cue is not presented to the player if the number of times of operating the predetermined button in the success range reaches the predetermined number of times, the virtual game according to the embodiment does not become a work-oriented game that an operation is performed by simply watching the cue. That is, it is possible to present a timing that the player should perform an operation input, without spoiling the interest of the game.

In addition, in the embodiment, a command to be executed by the player object is selected and executed according to an instruction of the player; however, if the player selects an autoplay, a command may be selected and executed by a computer (i.e., the processor). In such a case, it is determined, during a time period that the player object 102 executes an action corresponding to a command that is executed by the processor, whether the A button is operated by the player in the success range that is set in advance corresponding to this action.

Moreover, in the embodiment, the progress of the game situation of the virtual game is made to differ depending on whether or not the operation of the A button is within the success range, but there is no need to be limited to this. As to the success range, if a great success range that is shorter than the success range is established in the success range, and if the A button is operated in this great success range, the game situation may be updated to be even more favorable to the player than if the A button is operated within the success range but outside the great success range. For example, the damage inflicted on the enemy object is made larger, the recovery value of the HP of the player object is made larger, the damage inflicted on the player object by the attack of the enemy object is made smaller, or the recovery value of the HP of the enemy object is made smaller.

Furthermore, if providing a range shorter than the success range, the guide presentation flag regarding the corresponding command may be turned off when the number of times that the operation of the A button reaches the number of times lesser than the first predetermined number of times.

Furthermore, in the embodiment, the number of success times and the number of failure times are the total number of times, respectively, but may be consecutive number of times.

Moreover, in the embodiment, the number of success times is counted when the guide is being presented, and the number of failure times is counted when the guide is not presented, thereby to turn on or off the guide presentation flag; however, it does not need to be limited. It is conceivable that accumulated values of the number of success times and the number of failure times are respectively stored if irrespective of presenting the guide, and the guide presentation flag may be turned on or off according to a comparison result of the accumulated values. When the accumulated value of the number of success times is larger than the accumulated value of the number of failure times, the guide presentation flag is turned off, and the accumulated value of the number of success times is smaller than the accumulated value of the number of failure times, the guide presentation flag is turned on. However, when the accumulated value of the number of success times is equal to the accumulated value of the number of failure times, the guide presentation flag may be turned on or off.

In addition, in the embodiment, the overall processing of the virtual game and the game control processing shown in FIG. 8-FIG. 12 are all executed by the processor 20 of the game apparatus 10; however, a part or all of them may be executed by an external computer capable of communicating with the game apparatus 10 so that the game apparatus 10 can acquire from the computer a result(s) of the processing in part or all. In such a case, a network game system or an information processing system is constituted by the game apparatus 10 and the computer that is communicably connected with the game apparatus 10.

Moreover, the structure of the game apparatus, various kinds of screens and specific numeral values shown in the embodiment are mere examples, should not be limited and can be appropriately changed according to actual products.

Moreover, if the same or similar result is obtainable, an order of the respective steps shown in the flowcharts may be exchanged.

Although certain example systems, methods, storage media, devices and apparatuses have been described herein, it is to be understood that the appended claims are not to be limited to the systems, methods, storage media, devices and apparatuses disclosed, but on the contrary, are intended to cover various modifications and equivalent arrangements included within the spirit and scope of the appended claims.

What is claimed is:

1. A non-transitory computer-readable storage medium having stored with an information processing program executable by a computer of an information processing apparatus that is capable of executing a game and comprises one or more processors, wherein the information processing program causes the one or more processors of the computer to execute:
making a character object utilized in the game perform a predetermined action;
acquiring operation input data to an operation input portion by a player;
judging, during a time period that the character object executes the predetermined action, whether an operation input by the player is performed on a timing that is associated in advance with the predetermined action, based on the operation input data;
updating a game situation of the game with a first manner when it is judged that the operation input by the player is not performed on the timing, and updating the game situation of the game with a second manner different from the first manner when it is judged that the operation input by the player is performed on the timing;
presenting, on the timing, a guide corresponding to the timing when a guide presentation flag is turned on;
storing number of success times that the operation input by the player is performed on the timing, in a storage; and
turning the guide presentation flag off when the number of success times satisfies a first change condition.

2. The storage medium according to claim 1, wherein the information processing program causes the one or more processors to execute:
storing number of failure times that the operation input by the player is not performed on the timing, in the storage; and
turning the guide presentation flag on when the number of failure times that the operation input by the player is not performed on the timing satisfies a second change condition after turning the guide presentation flag off.

3. The storage medium according to claim 1, wherein the information processing program causes the one or more processors to execute:
updating the game situation based on one predetermined action among a plurality of predetermined actions; and
storing the number of success times in the storage for each of the plurality of actions.

4. The storage medium according to claim 1, wherein the information processing program causes the one or more processors to execute: updating the game situation in favor of the player in a case where it is judged that the operation input is performed on the timing compared to a case where it is not judged that the operation input is performed on the timing.

5. The storage medium according to claim 1, wherein the game is a game that an enemy character object and the character object engage a battle, wherein the information processing program causes the one or more processors to execute: updating the game situation by changing a life parameter associated with the enemy character object by using a first value corresponding to the predetermined action.

6. The storage medium according to claim 5, wherein the information processing program causes the one or more processors to execute: updating the game situation by changing the life parameter by using a value larger than the first value in the case where it is judged that the operation input by the player is performed on the timing.

7. The storage medium according to claim 5, wherein the information processing program causes the one or more processors to execute:
making the enemy character object execute an enemy character action;
judging, during a time period that the enemy character object executes the enemy character action, whether an operation input by the player is performed on a timing that is associated in advance with the enemy action, based on the operation input data;
updating the life parameter associated with the character object by using a second value corresponding to the enemy character action in a case where the operation input is not performed;
updating the game situation by changing the life parameter associated with the character object by using a value smaller than the second value in the case where it is judged that the operation input is performed; and
presenting, in a case where the guide presentation flag associated with the enemy character action is turned-on on the timing associated in advance with the enemy character action, a guide corresponding to this timing.

8. The storage medium according to claim 5, wherein the game is a game that a plurality of enemy character objects and the character object engage a battle, wherein the information processing program causes the one or more processors to execute:
changing the life parameters associated with a first number of enemy character objects among the plurality of enemy character objects in a case where it is judged that the operation input by the player is not performed; and
updating the game situation by changing the life parameters associated with a second number of enemy character objects among the plurality of enemy character objects larger than the first number of enemy character objects in a case where it is judged that the operation input by the player is performed on the timing.

9. An information processing system capable of executing a game, wherein the information processing system causes one or more processors to execute:
making a character object utilized in the game perform a predetermined action;
acquiring operation input data to an operation input portion by a player;
judging, during a time period that the character object executes the predetermined action, whether an operation input by the player is performed on a timing that is associated in advance with the predetermined action, based on the operation input data;
updating a game situation of the game with a first manner when it is judged that the operation input by the player is not performed on the timing, and updating the game situation of the game with a second manner different from the first manner when it is judged that the operation input by the player is performed on the timing;
presenting, on the timing, a guide corresponding to the timing when a guide presentation flag is turned on;
storing number of success times that the operation input by the player is performed on the timing, in a storage; and
turning the guide presentation flag off when the number of success times satisfies a first change condition.

10. An information processing apparatus that is capable of executing a game and causes one or more processors of the information processing apparatus to execute:
making a character object utilized in the game perform a predetermined action;
acquiring operation input data to an operation input portion by a player;
judging, during a time period that the character object executes the predetermined action, whether an operation input by the player is performed on a timing that is associated in advance with the predetermined action, based on the operation input data;
updating a game situation of the game with a first manner when it is judged that the operation input by the player is not performed on the timing, and updating the game situation of the game with a second manner different from the first manner when it is judged that the operation input by the player is performed on the timing;
presenting, on the timing, a guide corresponding to the timing when a guide presentation flag is turned on;
storing number of success times that the operation input by the player is performed on the timing, in a storage; and
turning the guide presentation flag off when the number of success times satisfies a first change condition.

11. An information processing method of an inform processing apparatus capable of executing a game, wherein a computer of the information processing apparatus executes:
making a character object utilized in the game perform a predetermined action;
acquiring operation input data to an operation input portion by a player;
judging, during a time period that the character object executes the predetermined action, whether an operation input by the player is performed on a timing that is associated in advance with the predetermined action, based on the operation input data;
updating a game situation of the game with a first manner when it is judged that the operation input by the player is not performed on the timing, and updating the game situation of the game with a second manner different from the first manner when it is judged that the operation input by the player is performed on the timing;
presenting, on the timing, a guide corresponding to the timing when a guide presentation flag is turned on;
storing number of success times that the operation input by the player is performed on the timing, in a storage; and
turning the guide presentation flag off when the number of success times satisfies a first change condition.
